(19) United States
(12) Patent Application Publication
(10) Pub. No.: US 2007/0213011 A1
(43) Pub. Date: Sep. 13, 2007

(54) Method for controlling reverse channel rate in a cellular mobile communication system and system thereof

(75) Inventors: Dong-Hee Kim, Yongin-si (KR); Hi-Chan Moon, Yongin-si (KR); Hwan-Joon Kwon, Hwaseong-si (KR); Jae-Chon Yu, Suwon-si (KR); Yu-Chul Kim, Seoul (KR); Jin-Kyu Han, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/709,918

(22) Filed: Feb. 22, 2007

(30) Foreign Application Priority Data
Feb. 22, 2006 (KR) 17230/2006

(51) Int. Cl. H04B 1/00; H04B 15/00

(52) U.S. Cl. 455/63.1

(57) ABSTRACT

Disclosed is a method for controlling reverse transmission power in a cellular mobile communication system. A base station measures interference in a cell divided into a plurality of beamforming areas, determines an Interference Availability Bit (IAB) of a specific area where the measured interference is greater than or less than a threshold, and forms a beam so as to transmit the determined IAB to a beamforming area including the specific area. A terminal receiving the formed beam receives the IAB, and controls reverse transmission power according to the received IAB.

### PRIORITY

This application claims the benefit under 35 U.S.C. §119(a) of a Korean Patent Application filed in the Korean Intellectual Property Office on Feb. 22, 2006 and assigned Serial No. 2006-17230, the contents of which are incorporated herein by reference.

### BACKGROUND OF THE INVENTION

1. Field of the Invention

The present invention relates generally to a system and method for controlling a reverse channel rate in a cellular mobile communication system, and in particular, to a system and method for controlling a reverse channel rate in a cellular mobile communication system supporting a multimedia service.

2. Description of the Related Art

Generally, in cellular mobile communication systems, a base station (or Access Network (AN)) measures interference in its service region and transmits information on the measured interference to a terminal (or Access Terminal (AT)) in order to control a reverse channel rate. Based on the received interference information, the terminal sets transmission power or channel rate. In this manner, the base station improves throughput in its service region. Herein, the terms ‘controlling transmission power’ and ‘controlling channel rate’ have the same meaning, the terms ‘transmission power’ and ‘channel rate’ have the same meaning, a transmission direction from a base station to a terminal is referred to as a ‘forward direction’ and a transmission direction from a terminal to a base station is referred to as a ‘reverse direction.’

FIG. 1 illustrates a method for controlling reverse channels in a conventional cellular mobile communication system. In FIG. 1, a service region of each sector is shown by a dotted line.

Referring to FIG. 1, each sector transmits 1-bit or 2-bit Interference Availability Bit (IAB) indicating interference therein in the forward direction. A base station of each sector measures interference received via a reception antenna, compares the measured interference with a threshold, and sets an IAB according to the comparison. If the measured interference is greater than the threshold, the base station sets the IAB as ‘DOWN’ which commands terminals to decrease their transmission power. However, if the measured interference is less than the threshold, the base station sets the IAB as ‘UP’ which commands terminals to increase their transmission power. The IAB is determined independently for each sector, and is periodically transmitted by a base station of each sector.

If each base station transmits the IAB, all terminals located in the corresponding sector and its neighbor sectors can receive the IAB. In an Orthogonal Frequency Division Multiple Access (OFDMA) system, because interference between terminals in a sector is not considered, the terminals in the corresponding sector have no need to receive the IAB in the corresponding sector. However, in a Code Division Multiple Access (CDMA) system, because interference occurs even between terminals in a sector, all terminals located in the corresponding sector and its neighbor sectors need to receive the IAB in the corresponding sector.

A terminal receiving the IAB restricts its transmission power based on the received IAB. For example, the terminal increases the transmission power for IAB with ‘UP’ command, and decreases the transmission power for IAB with ‘DOWN’ command. The terminal can increase/decrease the transmission power directly in this manner, or can adjust the transmission power based on probability.

An AT 101 of FIG. 1 receives an IAB1 and an IAB2 from a sector 1 and a sector 2, respectively, and determines its transmission power using the received two IABs. If a plurality of IABs are received in this manner, the terminal gives a weight to each IAB in determining its transmission power.

In this system, if interference received from a sector increases, a base station of each sector decreases transmission power of terminals using the IAB, thereby restricting the interference. However, even when a small number of terminals cause interference in a specific area, the base station may reduce the transmission power of all the terminals using the IAB, causing a reduction in the entire reverse throughput of the sector.

### SUMMARY OF THE INVENTION

An aspect of the present invention is to address at least the problems and/or disadvantages and to provide at least the advantages described below. Accordingly, an aspect of the present invention is to provide a reverse channel rate control system and method for improving throughput using a multi-input/output antenna in a cellular mobile communication system.

Another aspect of the present invention is to provide a system and method for controlling a reverse channel rate by controlling only the interference caused by the terminals located in a specific area using multiple antenna techniques in a cellular mobile communication system.

According to the present invention, there is provided a base station apparatus for controlling reverse transmission power in a cellular mobile communication system, including an interference measurer for measuring interference in a cell which is under the control of the base station apparatus, an, IAB, determiner for determining an IAB of a specific area included in a plurality of beamforming areas divided from the cell which is under the control of the base station apparatus, wherein the measured interference is less or greater than a threshold in the specific area, and a beamforming block for forming a beam so as to transmit the determined IAB to any one of the beamforming areas divided from the cell which is under the control of the base station apparatus, including the corresponding specific area.

The beamforming block includes a multiplexer for generating symbols by inserting the IAB determined for the at least one specific area and a pilot for demodulation of the IAB into their associated subcarriers; and a beamformer for forming a beam in a specific direction by setting weights for the subcarriers corresponding to the symbols.

The beamforming block further includes an Inverse Fast Fourier Transform (IFFT) block for performing IFFT on the beamformed signal received from the beamformer and transmitting the IFFT-processed signal to the corresponding beamforming area.

The pilot is beamformed with a weight applied to the corresponding subcarrier.

According to the present invention, there is provided a cellular mobile communication system for controlling reverse transmission power, including a base station for measuring interference in a cell divided into a plurality of beamforming areas, determining an IAB of a specific area where the measured interference is less or greater than a threshold, and forming a beam so as to transmit the determined IAB to a beamforming area including the specific area, and a terminal for receiving the IAB and controlling reverse transmission power according thereto.

The terminal includes a receiver for receiving beamformed signals from the at least one base station, a pilot receiver for receiving pilot signals of the received signals, a channel estimator for extracting an IAB based on the pilot signal and a controller for controlling transmission power of the terminal based on the IAB.

If the pilot signals of the received signals are common pilots which means that pilots are not beamformed, the pilot receiver estimates channel responses of the beamformed signals by applying to the received pilot signals a beamforming coefficient predetermined with the base station.

The channel estimator extracts an IAB that is transmitted with a beam for which the received strength is greater than or equal to a threshold.

If there are a plurality of the extracted IABs, the controller controls transmission power of the terminal by applying to each IAB a weight that is determined considering an influence given to each sector.

According to the present invention, there is provided a method for controlling reverse transmission power in a base station of a cellular mobile communication system, including measuring interference in a cell that is under the control of the base station, determining an IAB of a specific area included in a plurality of beamforming areas divided from the cell which is under the control of the base station, wherein the measured interference is less or greater than a threshold in the specific area, and forming a beam so as to transmit the determined IAB to any one of the beamforming areas divided from the cell which is under the control of the base station, including the corresponding specific area.

Forming the beam includes generating symbols by inserting the IAB determined for the at least one specific area and a pilot for demodulation of the IAB into their associated subcarriers, and forming a beam in a specific direction by setting weights for the subcarriers corresponding to the symbols.

Forming the beam further includes performing IFFT on the beamformed signal and transmitting the IFFT-processed signal to the corresponding beamforming area.

Forming the beam also includes beamforming the pilot with a weight corresponding to the subcarrier.

According to the present invention, there is provided a method for controlling reverse transmission power in a cellular mobile communication system, including (a) a base station measuring interference in a cell divided into a plurality of beamforming areas, determining an IAB of a specific area where the measured interference is less or greater than a threshold, and forming a beam so as to transmit the determined IAB to a beamforming area including the specific area, and (b) a terminal receiving the formed beam, receiving the IAB, and controlling reverse transmission power according to the received IAB.

Step (a) further includes generating symbols by inserting the IAB determined for the at least one specific area and a pilot for demodulation of the IAB into their associated subcarriers, and forming a beam in a specific direction by setting weights for the subcarriers corresponding to the symbols.

Step (a) also includes performing IFFT on the beamformed signal and transmitting the IFFT-processed signal to the corresponding beamforming area.

Forming the beam includes beamforming the pilot with a weight corresponding to the subcarrier.

Step (b) further includes receiving beamformed signals from the at least one base station, receiving pilot signals of the received signals, extracting an IAB based on the pilot signal, and controlling transmission power of the terminal based on the IAB.

The reception of pilot signals includes, if the pilot signals of the received signals are common pilots, estimating channel responses of the beamformed signals by applying to the received pilot signals a beamforming coefficient predetermined with the base station.

The extraction of an IAB includes extracting an IAB that is transmitted with the received beam, if received strength of the received beam is greater than or equal to a threshold.

Controlling the transmission power includes, if there are a plurality of the extracted IABs, controlling transmission power of the terminal by applying a weight that is determined considering an influence given to each sector, to each IAB.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a method for controlling reverse channels in a conventional cellular mobile communication system;

FIG. 2 illustrates a cellular mobile communication system employing a reverse channel control method according to an embodiment of the present invention;

FIG. 3 illustrates a frame structure applied to a cellular mobile communication system according to an embodiment of the present invention;

FIG. 4 illustrates a base station for performing a reverse channel control method according to an embodiment of the present invention;

FIG. 5 illustrates a terminal for performing a reverse channel control method according to an embodiment of the present invention;

FIG. 6 illustrates an OFDM symbol structure using a beamformed pilot scheme in a base station according to an embodiment of the present invention;

FIG. 7 illustrates an OFDM symbol structure using a common pilot scheme in a base station according to an embodiment of the present invention;

FIG. 8 illustrates a process of generating an IAB in a base station according to an embodiment of the present invention; and

FIG. 9 illustrates a reverse channel rate control method performed in a terminal according to an embodiment of the present invention.

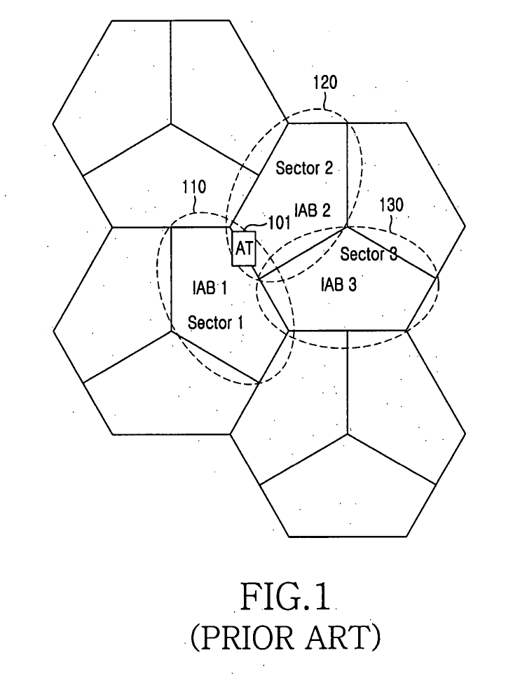

### DETAILED DESCRIPTION OF THE PREFERRED EMBODIMENTS

Preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for the sake of clarity and conciseness.

According to the present invention, a base station controls only the interference caused by the terminals located in a specific area using multiple antenna techniques in order to improve throughput in each sector.

The multiple antenna techniques included in the base station is a beamforming, which beamforms a specific signal in a desired direction by controlling phases of arranged antennas and transmits the beamformed signal.

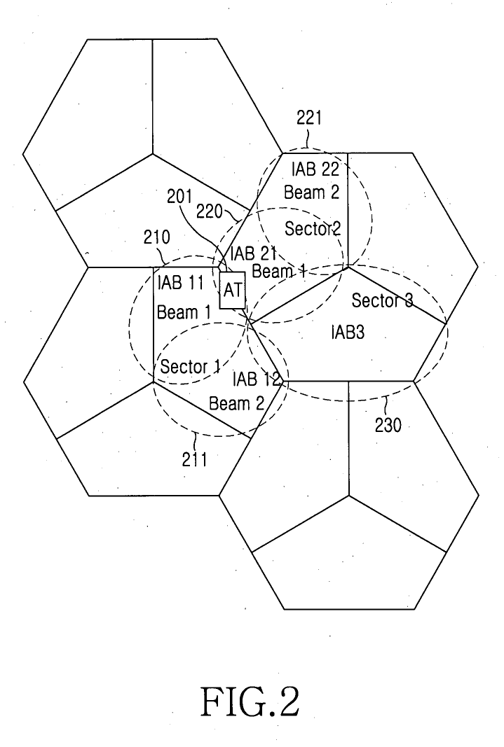

FIG. 2 illustrates a cellular mobile communication system employing a reverse channel control method according to an embodiment of the present invention. Sector 1 and sector 2 shown in this embodiment are controlled by a base station with multiple transmission antennas, and sector 3 is controlled by a base station with a single transmission antenna. Although it is shown in FIG. 2 that two transmission antennas are installed in each of the sector 1 and the sector 2, the number of transmission antennas installed in each sector can be 3 or more according to the base station. In a sector with 3 transmission antennas, no more than 3 IABs beamformed from the antennas are transmitted in their corresponding directions, dividing the corresponding sector uniformly or non-uniformly.

Referring back to FIG. 2, sector 1 and Sector 2 with multiple transmission antennas transmit IABs using beamforming. A value of the IAB is generated independently for each beam. Accordingly, IABs transmitted into service regions 210 and 211 of a Beam 1 and a Beam 2 in Sector 1 are defined as IAB11 and IAB12, respectively, and IABs transmitted into service regions 220 and 221 of Beam 1 and Beam 2 in Sector 2 are defined as IAB21 and IAB22, respectively. As Sector 3 uses a single transmission antenna, an IAB transmitted into a service region 230 of the sector is defined as IAB3.

Referring to FIG. 2, if it is determined that an AT 201 causes substantial interference, the base station of Sector 1 transmits the IAB11 of ‘DOWN’ command to service region 210 via a transmission antenna of Beam 1, and the base station of Sector 2 transmits the IAB21 of ‘DOWN’ command to service region 220 via the transmission antenna of Beam 1. Therefore, it is possible to allow only the terminals causing the interference to decrease their transmission power, and prevent all terminals in the sector from unnecessarily decreasing their transmission power. The base stations of Sector 1 and Sector 2 can transmit the IAB12 and the IAB22 of ‘UP’ commands so as to increase transmission power in the service regions of Beam 2. As a result, the entire throughput of the cellular system can be improved.

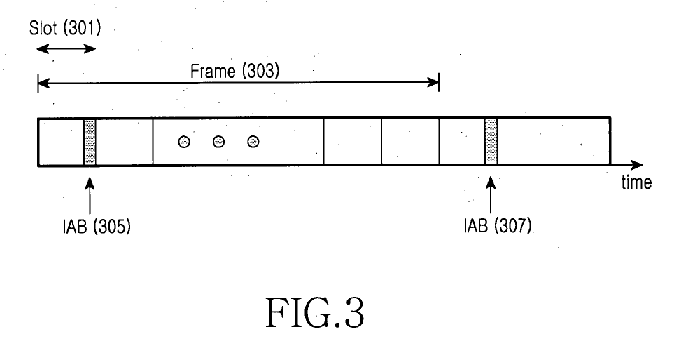

FIG. 3 illustrates a frame structure applied to a cellular mobile communication system according to an embodiment of the present invention.

Referring to FIG. 3, one Frame 303 is composed of a plurality of slots. The number of slots can be changed to 6 or 12 according to the system. IABs 305 and 307 are inserted into specific regions in each Frame 303, and periodically transmitted by a base station in each sector. For example, in the OFDM system, the IABs are transmitted through OFDM symbols.

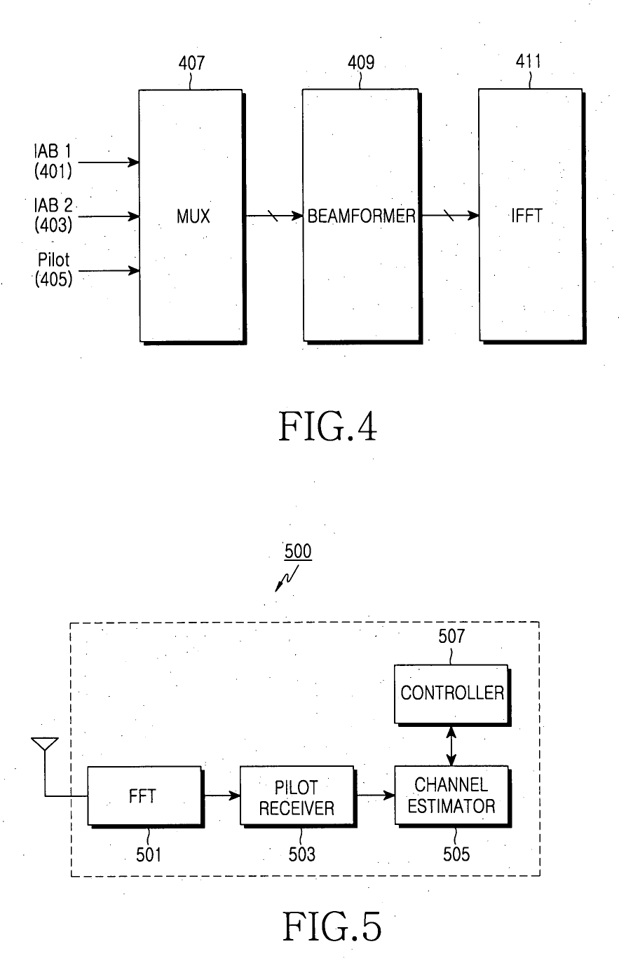

FIG. 4 illustrates a base station for performing a reverse channel control method according to an embodiment of the present invention, wherein a transmission scheme of beamformed IABs is shown. The present invention transmits a plurality of IABs through a plurality of beams. For convenience, however, it is assumed herein that 2 IABs 401 and 403 are input to a MUltipleXer (MUX).

Referring to FIG. 4, a base station inputs a plurality of IABs to a MUX 407 in order to transmit a plurality of IABs through a plurality of beams. In addition, the base station inputs a Pilot 405 for channel estimation to the MUX 407 in order to demodulate the IABs. Herein, the Pilot 405 is used even for channel estimation for demodulating the IABs, and can also be used when a terminal measures received strengths of beams in order to determine the beams that it will monitor.

The MUX 407 generates symbols by inserting the input IAB1 401, IAB2 403 and Pilot 405 into subcarriers and multiplexes the symbols according to a transmission scheme of the present invention. Thereafter, the MUX 407 delivers the multiplexed symbol(s) to a beamformer 409. The MUX 407 can support both time multiplexing and frequency multiplexing. If the MUX 407 is a frequency multiplexer, the IAB1 401, IAB2 403 and Pilot 405 are transmitted through one OFDM symbol, and if the MUX 407 is a time multiplexer, the IAB1 401, IAB2 403 and Pilot 405 are transmitted through a plurality of OFDM symbols. Alternatively, the IAB1 401, IAB2 403 and Pilot 405 can simultaneously undergo time multiplexing and frequency multiplexing. The MUX 407 sets a plurality of subcarriers according to the transmission scheme of the present invention.

The beamformer 409 forms a corresponding beam using a subcarrier including the IAB1 and IAB2 from the MUX 407, and sets a weight thereof.

An IFFT block 407 performs IFFT on a received beamformed signal and finally transmits the IFFT-processed signal to a terminal.

FIG. illustrates a terminal for performing a reverse channel control method according to an embodiment of the present invention.

Referring to FIG. 5, a terminal 500 includes an FFT block 501, a pilot receiver 503, a channel estimator 505 and a controller 507. A description of the parts unrelated to the present invention is omitted herein.

In the terminal 500, the FFT block 501 performs FFT on a beamformed signal received from a corresponding base station. The pilot receiver 503 receives a pilot to determine a beam that it will monitor. Herein, the pilot can be a common pilot or a beamformed pilot. A transmission scheme of the pilot will be described below.

The channel estimator 505 receives an IAB using a received pilot. The controller 507 receives the IAB from the channel estimator 505. If the received pilot is a beamformed pilot, the channel estimator 505 receives the IAB through an estimated channel response. If the received pilot is a common pilot, the channel estimator 505 receives the IAB through a channel response using a beamforming coefficient. Upon receipt of the IAB from the channel estimator 505, the controller 507 controls transmission power based on the received IAB.

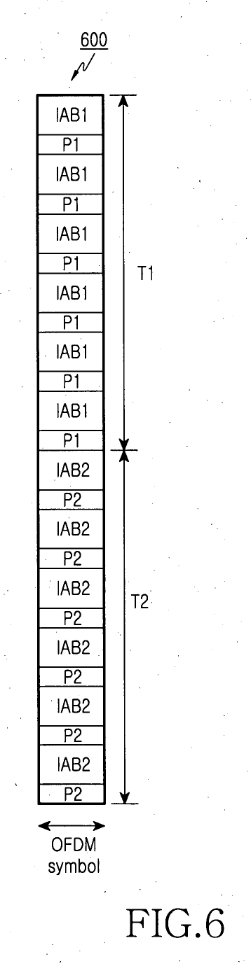

FIG. 6 illustrates an OFDM symbol structure using a beamformed pilot scheme in a base station according to an embodiment of the present invention, wherein the vertical axis indicates frequency and the horizontal axis indicates time.

Referring to FIG. 6, the upper half subcarriers T1 among the subcarriers are used for sending an IAB1, and the lower half subcarriers T2 are used for sending an IAB2. The subcarriers corresponding to the IAB1 and the IAB2 are beamformed with weights corresponding to their associated Beam 1 and Beam 2 by a beamformer 409 of a base station. Similarly, as for the pilots, the upper half pilots P1 are beamformed with a weight corresponding to Beam 1 and the lower half pilots P2 are beamformed with a weight corresponding to Beam 2 before transmission, so as to help demodulation of IAB1 and IAB2. A terminal, when it uses the beamformed pilot scheme according to the present invention, receives the IAB1 through a channel response estimated using the beamformed Pilot P1 and receives the IAB2 through a channel response estimated using the beamformed Pilot P2.

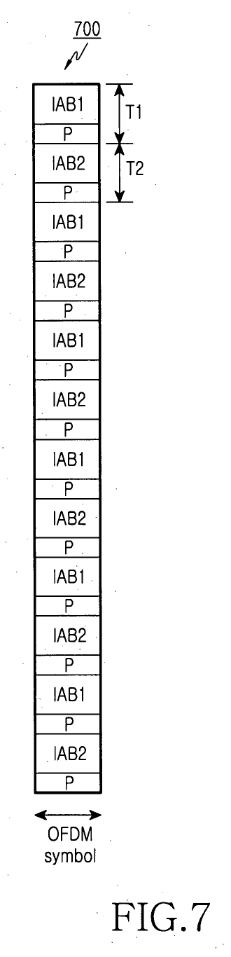

FIG. 7 illustrates an OFDM symbol structure using a common pilot scheme in a base station according to an embodiment of the present invention.

Referring to FIG. 7, because the common pilot scheme uses a common pilot channel, there is no beamforming process in the base station. Therefore, unlike the beamformed pilot scheme, the common pilot scheme uniformly mixes IAB1 and IAB2, and arranges them over the full band. Subcarriers corresponding to IAB1 and IAB2 are beamformed with weights corresponding to their associated Beam 1 and Beam 2. Although the common pilot is not beamformed, because a terminal is previously aware of a beamforming coefficient through an agreement with the base station, the terminal can determine channel responses of Beam 1 and Beam 2, beamformed by applying the beamforming coefficient to received common pilots.

Similarly, even in the common pilot scheme, the beamformed pilot can be used instead of the common pilot. In FIGS. 6 and 7, because IAB1 and IAB2 are beamformed, a method for transmitting the same subcarriers is also available. In this case, however, interbeam interference may occur. In addition, it is also possible to transmit IABs using only partial subcarriers, and transmit data or control signals using the remaining subcarriers.

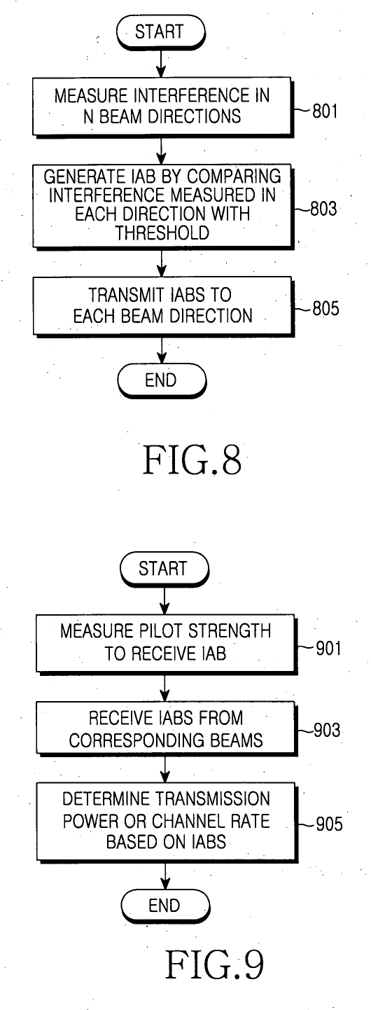

FIG. 8 illustrates a process of generating an IAB in a base station according to an embodiment of the present invention.

Referring to FIG. 8, each base station of the present invention, as it includes a multi-input/output antenna, measures interferences received in specified directions in step 801. That is, the base station can measure interferences in corresponding beam directions according to the multi-input/output antenna. Herein, the number of the beam directions is N. After measuring the interference received for each beam, the base station compares in step 803 the measured interference with a threshold to determine the amount of interference. The base station generates a value of the IAB for each beam according to the amount of interference. The IAB generated for each beam is beamformed in each beam direction and then transmitted in step 805.

FIG. 9 illustrates a reverse channel rate control method performed in a terminal according to an embodiment of the present invention.

Referring to FIG. 9, in step 901, a terminal measures received strength of each beam through pilots or preambles transmitted from beams of neighbor sectors. If the measured received strength of the beam is greater than or equal to a threshold, the terminal receives in step 903 an IAB transmitted through a corresponding beam, determining that the received beam affects its own transmission power. Upon receipt of a plurality of IABs, the terminal gives in step 905 a weight considering the influence given to a beam of each sector, and controls its transmission power or channel rate depending on the IABs.

As can be understood from the foregoing description, according to the present invention, a base station with a multi-input/output antenna generates an IAB considering only the interference in a specific area, performs beamforming thereon, and provides the resulting information to a terminal, thereby efficiently controlling a reverse channel rate and thus contributing to an increase in throughput in the sector.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A base station apparatus for controlling reverse transmission power in a cellular mobile communication system, the apparatus comprising:
an interference measurer for measuring interference in a cell which is under the control of the base station apparatus;
an Interference Availability Bit (IAB) determiner for determining an IAB of a specific area included in a plurality of beamforming areas divided from the cell, wherein the measured interference is greater than or less than a threshold in the specific area; and
a beamforming block for forming a beam so as to transmit the determined IAB to any one of the beamforming areas divided from the cell, including the specific area.

2. The base station apparatus of claim 1, wherein the beamforming block comprises:
a multiplexer for generating symbols by inserting the IAB determined for the at least one specific area and a pilot for demodulation of the IAB into their associated subcarriers; and
a beamformer for forming the beam in a specific direction by setting weights for the subcarriers corresponding to the symbols.

3. The base station apparatus of claim 2, wherein the beamforming block further comprises an Inverse Fast Fourier Transform (IFFT) block for performing IFFT on the beamformed signal received from the beamformer and transmitting the IFFT-processed signal to the corresponding beamforming area.

4. The base station apparatus of claim 2, wherein the pilot is beamformed with a weight applied to the corresponding subcarrier.

5. A cellular mobile communication system for controlling reverse transmission power, comprising:
a base station for measuring interference in a cell divided into a plurality of beamforming areas, determining an Interference Availability Bit (IAB) of a specific area where the measured interference is greater than or less than a threshold, and forming a beam so as to transmit the determined IAB to a beamforming area including the specific area; and
a terminal for receiving the IAB and controlling reverse transmission power according to the received IAB.

6. A terminal apparatus for controlling reverse transmission power, comprising:
a receiver for receiving beamformed signals from the at least one base station;
a pilot receiver for receiving pilot signals of the received signals;
a channel estimator for extracting an IAB based on the pilot signal; and
a controller for controlling transmission power of the terminal based on the IAB.

7. The terminal apparatus of claim 6, wherein if the pilot signals of the received signals are common pilots, the pilot receiver estimates channel responses of the beamformed signals by applying to the received pilot signals a beamforming coefficient predetermined with the base station.

8. The terminal apparatus of claim 6, wherein the channel estimator extracts an IAB that is transmitted with a beam having a received strength that is greater than or equal to a threshold.

9. The terminal apparatus of claim 6, wherein if there are a plurality of the extracted IABs, the controller controls transmission power of the terminal by applying to each IAB a weight that is determined considering an influence given to each sector.

10. A method for controlling reverse transmission power in a base station of a cellular mobile communication system, the method comprising:
measuring interference in a cell that is under the control of the base station;
determining an Interference Availability Bit (IAB) of a specific area included in a plurality of beamforming areas divided from the cell, wherein the measured interference is greater than or less than a threshold in the specific area; and
forming a beam so as to transmit the determined IAB to any one of the beamforming areas divided from the cell, including the specific area.

11. The method of claim 10, wherein forming the beam further comprises:
generating symbols by inserting the IAB determined for the at least one specific area and a pilot for demodulation of the IAB into their associated subcarriers; and
forming a beam in a specific direction by setting weights for the subcarriers corresponding to the symbols.

12. The method of claim 11, wherein forming the beam further comprises:
performing Inverse Fast Fourier Transform (IFFT) on the beamformed signal and transmitting the IFFT-processed signal to the corresponding beamforming area.

13. The method of claim 11, wherein forming the beam further comprises:
beamforming the pilot with a weight corresponding to the subcarrier.

14. A method for controlling reverse transmission power in a cellular mobile communication system, the method comprising the steps of:
(a) measuring, by a base station, interference in a cell divided into a plurality of beamforming areas, determining an Interference Availability Bit (IAB) of a specific area where the measured interference is greater than or less than a threshold, and forming a beam so as to transmit the determined IAB to a beamforming area including the specific area; and
(b) receiving, by a terminal, the formed beam, receiving the IAB, and controlling reverse transmission power according to the received IAB.

15. The method of claim 14, wherein step (a) further comprises:
generating symbols by inserting the IAB determined for the at least one specific area and a pilot for demodulation of the IAB into their associated subcarriers; and
forming a beam in a specific direction by setting weights for the subcarriers corresponding to the symbols.

16. The method of claim 15, wherein step (a) further comprises:
performing Inverse Fast Fourier Transform (IFFT) on the beamformed signal and transmitting the IFFT-processed signal to the corresponding beamforming area.

17. The method of claim 15, wherein forming the beam further comprises beamforming the pilot with a weight corresponding to the subcarrier.

18. A method for controlling reverse transmission power in a terminal, the method comprising the steps of:
receiving beamformed signals from the at least one base station;
receiving pilot signals of the received signals;
extracting an IAB based on the pilot signal; and
controlling transmission power of the terminal based on the IAB.

19. The method of claim 18, wherein receiving the pilot signals further comprises estimating, if the pilot signals of the received signals are common pilots, channel responses of the beamformed signals by applying to the received pilot signals a beamforming coefficient predetermined with the base station.

20. The method of claim 18, wherein extracting the IAB further comprises extracting an IAB that is transmitted with the received beam, if a received strength of the received beam is greater than or equal to a threshold.

21. The method of claim 18, wherein controlling the transmission power further comprises controlling transmission power of the terminal, if there are a plurality of the extracted IABs, by applying to each IAB a weight that is determined considering an influence given to each sector.
